(19) United States
(12) Patent Application Publication
(10) Pub. No.: US 2024/0097807 A1
(43) Pub. Date: Mar. 21, 2024

(54) UPLINK PATHLOSS CALCULATION IN A WIRELESS COMMUNICATION SYSTEM

(71) Applicant: Apple Inc., Cupertino, CA (US)

(72) Inventors: Dongzhou YANG, Beijing (CN); Lijie ZHANG, Beijing (CN); Kai ZHANG, Beijing (CN); Zhiwei WANG, Beijing (CN); Qiang MIAO, Beijing (CN); Lele CUI, Beijing (CN)

(73) Assignee: Apple Inc., Cupertino, CA (US)

(21) Appl. No.: 18/470,601

(22) Filed: Sep. 20, 2023

Related U.S. Application Data
(60) Provisional application No. 63/408,757, filed on Sep. 21, 2022.

(51) Int. Cl. H04B 17/309

(52) U.S. Cl. CPC H04B 17/347

(57) ABSTRACT

Some aspects relate to apparatuses and methods for calculating an uplink pathloss in a wireless communication system. A user equipment (UE) can be configured to perform operations for calculating the uplink pathloss. The operations can include determining a transmission power of a physical uplink shared channel (PUSCH) transmission for a UE, Txp_{PUSCH}, where the PUSCH transmission is from the UE to a base station. The operations can further include determining a receiving power of a sounding reference signal (SRS) by the base station, Rxpₛᵣₛ; and further calculating the uplink pathloss based on the transmission power of the PUSCH transmission Txp_{PUSCH} and the receiving power of the SRS Rxpₛᵣₛ.

### RELATED APPLICATIONS

This application claims benefit of U.S. Provisional Patent Application No. 63/408,757 filed Sep. 21, 2022, the content of which is herein incorporated by references in its entirety.

### BACKGROUND

### Field

The described aspects generally relate to the uplink pathloss calculation of a wireless channel in a wireless communication system.

### Related Art

A user equipment (UE) communicates with a base station, such as an evolved Node B (eNB), a next generation node B (gNB), or other base station, in a wireless communication network or system. A wireless communication system can include a fifth generation (5G) system, a New Radio (NR) system, a long term evolution (LTE) system, a combination thereof, or some other wireless systems. In addition, a wireless communication system can support a wide range of use cases such as enhanced mobile broad band (eMBB), massive machine type communications (mMTC), ultra-reliable and low-latency communications (URLLC), and enhanced vehicle to anything communications (eV2X). Devices in wireless communication systems may control the signal transmissions power to reduce the interference while saving power. The transmission power control may be determined based on channel characteristics, such as pathloss, which may be impacted by parameters such as propagation distances, the frequency of transmission, channel interference, and the propagation environment.

### SUMMARY

Some aspects of this disclosure relate to apparatuses and methods for implementing techniques for calculating uplink pathloss for a wireless communication channel. An uplink pathloss may be calculated or determined based on a transmission power of a physical uplink shared channel (PUSCH) transmission, and a receiving power of a sounding reference signal (SRS) in a wireless system.

Some aspects of this disclosure relate to a UE. The UE may include a transceiver, and a processor communicatively coupled to the transceiver. The transceiver is configured to enable wireless communication over a wireless network with a base station. The processor is configured to perform operations for calculating an uplink pathloss. The operations can include determining a transmission power of a PUSCH transmission for a UE, Txp_{PUSCH}, where the PUSCH transmission is from the UE to a base station. In some embodiments, the transmission power of the PUSCH transmission Txp_{PUSCH} can be determined based on a power headroom report (PHR).

In some embodiments, the operations can further include determining a receiving power of a SRS by the base station, Rxpₛᵣₛ; and further calculating the uplink pathloss based on the transmission power of the PUSCH transmission Txp_{PUSCH} and the receiving power of the SRS Rxpₛᵣₛ. In some embodiments, the operations can include determining a difference between the transmission power of the SRS Txpₛᵣₛ and the receiving power of the SRS Rxpₛᵣₛ, by a formula PLₛᵣₛ=Txpₛᵣₛ−Rxpₛᵣₛ, and further calculating the uplink pathloss based on the formula PLₛᵣₛ. In some embodiments, the transmission power of the SRS, Txpₛᵣₛ, can be determined based on the transmission power of the PUSCH transmission Txp_{PUSCH}.

In some embodiments, when a sum of the transmission power of the SRS Txpₛᵣₛ and the transmission power of the PUSCH transmission Txp_{PUSCH} is not limited by a maximum transmit power level (MTPL), the transmission power of the SRS Txpₛᵣₛ can be determined based on the transmission power of the PUSCH transmission Txp_{PUSCH}, and a power difference ΔM_{PRB} between a first transmission power used to transmit a first physical resource block (PRB) for the SRS and a second transmission power used to transmit a second PRB for the PUSCH transmission, where Txpₛᵣₛ can be calculated by a formula Txpₛᵣₛ=Txp_{PUSCH}+ΔM_{PRB}.

In some embodiments, when a sum of the transmission power of the SRS Txpₛᵣₛ and the transmission power of the PUSCH transmission Txp_{PUSCH} is limited by a MTPL, the transmission power of the SRS Txpₛᵣₛ can be determined based on the transmission power of the PUSCH transmission Txp_{PUSCH} and a maximum power reduction (MPR) ΔMPR, based on a formula Txpₛᵣₛ=Txp_{PUSCH}−ΔMPR.

In some embodiments, the transmission power of the SRS Txpₛᵣₛ can be determined based on the transmission power of the PUSCH transmission Txp_{PUSCH} and a power difference ΔP_{MCS} determined based on one or more modulation and coding schemes (MCS), Txpₛᵣₛ=Txp_{PUSCH}+ΔP_{MCS}. The power difference ΔP_{MCS} can be determined based on a first MCS used when the receiving power of the SRS Rxpₛᵣₛ is being measured, and a second MCS that is adjusted based on an uplink Block Error Ratio (BLER) measurement.

In some embodiments, the SRS can be a narrowband SRS. The operations to calculate the pathloss can further include determining a difference value, ΔRxₛᵣₛ, between a narrowband SRS signal to noise ratio (SINR) calculated based on the receiving power of the SRS Rxpₛᵣₛ and an average SRS SINR; determining a narrowband PUSCH receiving power, NB Rxp_{PUSCH}, determining an average wideband receiving power for the PUSCH transmission, by a formula Avg Rxp_{PUSCH}=NB Rxp_{PUSCH}+ΔRxₛᵣₛ; and calculating the uplink pathloss based on the Txp_{PUSCH} and the average wideband receiving power for the PUSCH transmission Avg Rxp_{PUSCH}, by a formula PL_{PUSCH}=Txp_{PUSCH}−Avg Rxp_{PUSCH}.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless system for calculating an uplink pathloss, according to some aspects of the disclosure.

FIG. 2 illustrates a block diagram of a UE implementing support for calculating an uplink pathloss in a wireless communication system, according to some aspects of the disclosure.

FIGS. 3A-3B illustrate example processes performed by a UE to calculate an uplink pathloss in a wireless communication system, according to some aspects of the disclosure.

FIG. 4 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless communication network or system, a user equipment (UE) communicates with a base station, such as an evolved Node B (eNB), a next generation node B (gNB), or other base station. A wireless communication system can include a fifth generation (5G) system, a New Radio (NR) system, a long term evolution (LTE) system, a combination thereof, or some other wireless systems. Devices in wireless communication systems may control the signal transmissions power to reduce interferences while saving power. The transmission power control may be determined based on channel characteristics, such as pathloss. The pathloss can measure the change in an electromagnetic wave power density (attenuation) during cross-section propagation.

In some embodiments, the pathloss can be estimated in an open-loop fashion using the uplink/downlink signal strengths such as a receiving power of a physical uplink shared channel (PUSCH) transmission. For example, a base station may calculate the pathloss based on PUSCH receiving power and power headroom report (PHR). However, pathloss calculated based on PUSCH receiving power and PHR can have large errors. In a system supporting both NR and LTE communication protocols, a base station may move voice communication from the NR system to a LTE system due to the pathloss calculated based on PUSCH receiving power and PHR. When the error of the pathloss calculated based on PUSCH receiving power and PHR is large, the voice communication can be moved to a LTE system even when the NR may have good quality support. In general, the PUSCH may be scheduled in a narrow band, and the pathloss calculation may be impacted by frequency selective fading. In some embodiments, the pathloss may be calculated further based on a transmission power of a sounding reference signal (SRS), where the SRS is a reference signal transmitted by the UE in the uplink direction which is used by the base station to estimate the uplink channel quality over a wider bandwidth. However, the SRS transmission power may not be the same as the PUSCH transmission power.

Embodiments herein present techniques for calculating an uplink pathloss in a wireless communication system. An uplink pathloss may be calculated or determined based on a transmission power of a PUSCH transmission, and a receiving power of a SRS in a wireless system. The receiving power of the SRS can be different from the transmission power of the SRS. Accordingly, there can be a difference between the transmission power of the SRS Txpₛᵣₛ and the receiving power of the SRS Rxpₛᵣₛ, which can be determined by a formula PLₛᵣₛ=Txpₛᵣₛ−Rxpₛᵣₛ. The uplink pathloss can be calculated based on the formula PLₛᵣₛ.

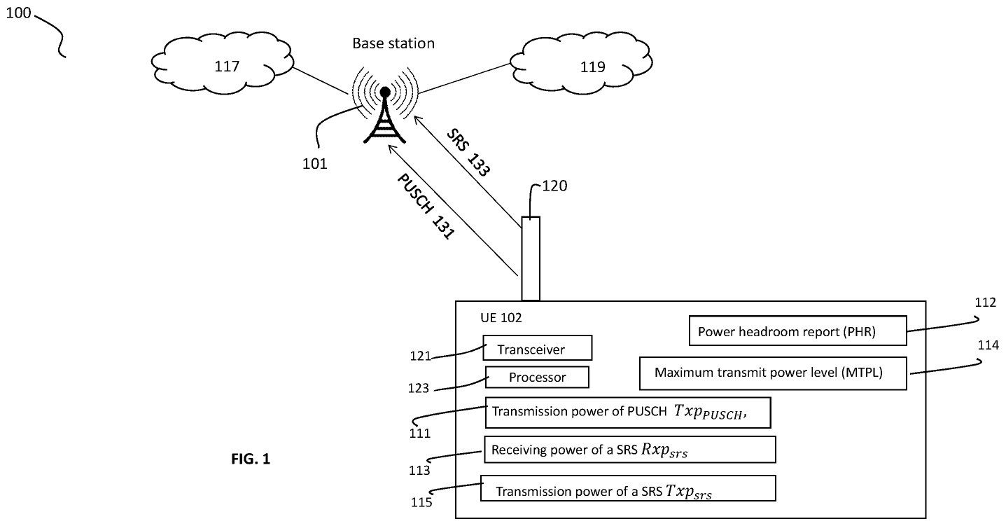

FIG. 1 illustrates an example wireless system 100 for calculating an uplink pathloss, according to some aspects of the disclosure. The wireless system 100 is provided for the purpose of illustration only and does not limit the disclosed aspects. As shown in FIG. 1, system 100 can include, but is not limited to, a network node (herein referred to as a base station) 101, and one or more UEs, such as a UE 102, a core network 117, and a core network 119, all communicatively coupled to each other. System 100 can further include additional components, not shown.

According to some aspects, base station 101 can include a node configured to operate based on a wide variety of wireless communication techniques such as, but not limited to, techniques based on 3rd Generation Partnership Project (3GPP) standards. For example, base station 101 can include a node configured to operate using Rel-16, Rel-17, or others. Base station 101 can be a fixed station, and may also be called a base transceiver system (BTS), an access point (AP), a transmission/reception point (TRP), an evolved NodeB (eNB), a next generation node B (gNB), or some other equivalent terminology. System 100 can operate using both licensed cellular spectrum (known as in-band communication) and unlicensed spectrum (known as out-band communication). In some embodiments, base station 101 may function as both an eNB for LTE services and coupled to core network 117 that may be a LTE core network, and a gNB for NR services and coupled to core network 119 that may be a NR core network. In some embodiments, base station 101 may be coupled to only the LTE core network, or the NR core network, or some other core network.

According to some aspects, UE 102 can be configured to operate based on a wide variety of wireless communication techniques. These techniques can include, but are not limited to, techniques based on 3GPP standards. For example, UE 102 can be configured to operate using Rel-16, Rel-17 or later. UE 102 can include, but is not limited to, a wireless communication device, a smart phone, a laptop, a desktop, a tablet, a personal assistant, a monitor, a television, a wearable device, an Internet of Things (IoTs), a vehicle's communication device, a mobile station, a subscriber station, a remote terminal, a wireless terminal, a user device, or the like. In some embodiments, UE 102 can communicate with LTE core network 117 and NR core network 119 through one or more base stations, such as base station 101.

According to some aspects, UE 102 can include an antenna array or system 120 having a plurality of antenna panels. In general, an antenna system can include one or more antenna panels. An antenna panel can include an array of antenna elements that can be located in close physical location to each other. An antenna element can be an omnidirectional antenna element, a quasi-omnidirectional antenna element, a directional antenna element, or any other antenna element. In some examples, antenna can be a smart antenna system, where all antenna elements are considered as pseudo-omni or quasi-sector-omni antenna elements and include a phase shifter. A directional beam, such as a transmission (Tx) beam or a receiving (Rx) beam, can be formed by adjusting the phase shifter of one or more of the antenna elements. An antenna element can include a dipole antenna element, a monopole antenna element, a patch antenna element, a loop antenna element, a microstrip antenna element, or any other type of antenna elements suitable for transmission of RF signals.

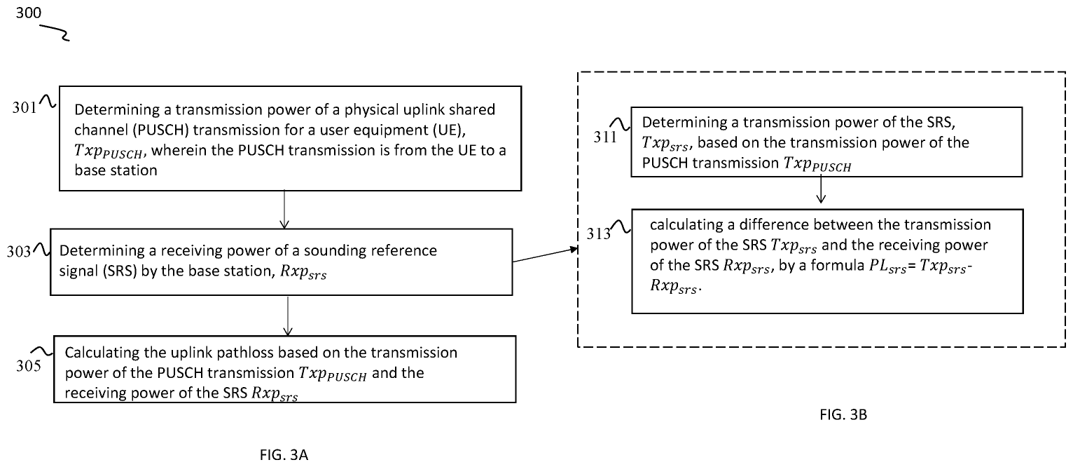

According to some aspects, UE 102 can include a transceiver 121 and a processor 123 communicatively coupled to transceiver 121. Transceiver 121 can be configured to wirelessly communicate with base station 101. According to some aspects, processor 123 can be configured to perform various operations. In some embodiments, UE 102 or processor 123 can perform operations to calculate an uplink pathloss in wireless system 100, such as operations shown in process 300 in FIG. 3. For example, processor 123 can determine a transmission power 111 of PUSCH transmission 131 for UE 102, Txp_{PUSCH}. In some embodiments, transmission power 111 of PUSCH transmission 131, Txp_{PUSCH}, can be determined based on a power headroom report (PHR) 112 stored by UE 102. In addition, processor 123 can determine a transmission power 115 of the SRS, Txpₛᵣₛ, and also a receiving power 113 of SRS 133 by base station 101, Rxpₛᵣₛ. In some embodiments, a sum of transmission power 115 of the SRS Txpₛᵣₛ and transmission power 111 of the PUSCH transmission Txp_{PUSCH} is limited by a maximum transmit power level (MTPL) 114.

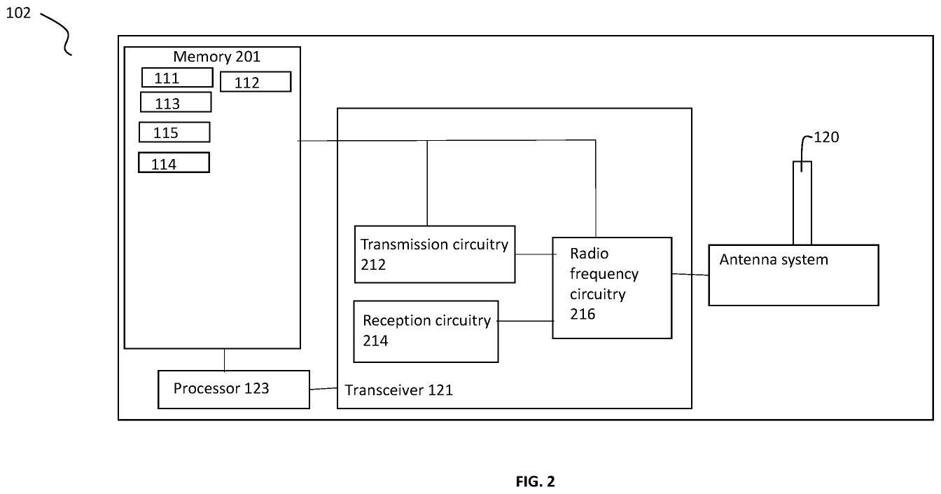

According to some aspects, UE 102 can be implemented according to a block diagram as illustrated in FIG. 2. Referring to FIG. 2, UE 102 can have antenna system 120 including one or more antenna elements to form various beams, coupled to transceiver 121 and controlled by processor 123. Transceiver 121 and antenna system 120 can be configured to enable wireless communication in a wireless network, such as wireless system 100, including wireless communication with base station 101. In detail, transceiver 121 can include radio frequency (RF) circuitry 216, transmission circuitry 212, and reception circuitry 214 to enable wireless communication with other UEs and/or a base station as discussed for wireless system 100. RF circuitry 216 can include multiple parallel RF chains for one or more of transmit or receive functions, each connected to one or more antenna elements of the antenna panel. In addition, processor 123 can be communicatively coupled to a memory 201, which are further coupled to transceiver 121. Various data can be stored in memory 201, as described below.

In some embodiments, memory 201 can store instructions, that when executed by processor 123 perform or cause to perform operations described herein, e.g., operations for calculating an uplink pathloss in a wireless communication system. Alternatively, processor 123 can be “hard-coded” to perform the operations described herein. In some embodiments, processor 123 can be configured to perform operations described for FIG. 3.

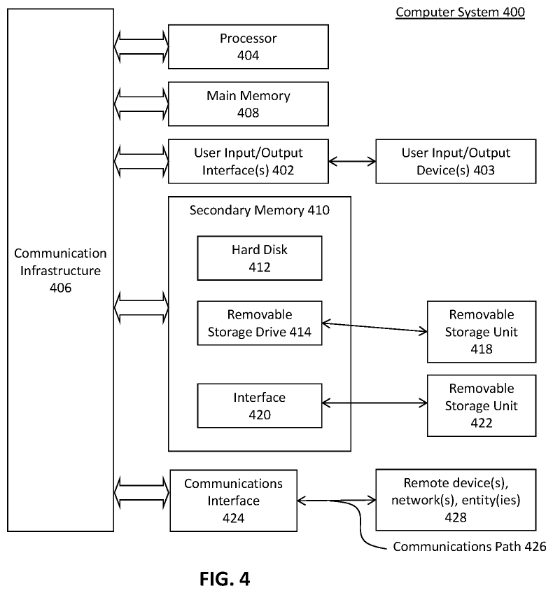

FIG. 3A illustrates an example process 300 performed by UE 102 to calculate an uplink pathloss in a wireless communication system, according to some aspects of the disclosure. Process 300 can be performed by UE 102, which may be implemented as shown in FIG. 2. Process 300 may also be performed by a computer system 400 of FIG. 4. Descriptions herein may be provided for the UE as examples. Process 300 is not limited to the specific aspects depicted in those figures and other systems may be used to perform the method as will be understood by those skilled in the art. It is to be appreciated that not all operations may be needed, and the operations may not be performed in the same order as shown in process 300.

At 301, processor 123 of UE 102 can determine a transmission power of a PUSCH transmission for the UE, Txp_{PUSCH}, where the PUSCH transmission is from UE 102 to a base station. For example, as shown in FIG. 1, for a PUSCH transmission 131 from UE 102 to base station 101, processor 123 can determine a transmission power 111 of PUSCH transmission 131 for UE 102, Txp_{PUSCH}. In some embodiments, transmission power 111 of PUSCH transmission 131, Txp_{PUSCH}, can be determined based on a power headroom report (PHR) 112 stored by UE 102. In some embodiments, PHR 112 may be configured by base station 101, and UE 101 can determine transmission power 111 based on configured PHR 112.

At 303, processor 123 of UE 102 can determine a receiving power of a SRS by the base station, Rxpₛᵣₛ. For example, for a SRS 133, processor 123 can determine a receiving power 113 of SRS 133 by base station 101, Rxpₛᵣₛ. FIG. 3B further describes step 303 of FIG. 3A.

In some embodiments, referring to FIG. 3B, in order to determine the receiving power of a SRS by the base station, Rxpₛᵣₛ, at 311, processor 123 can determine a transmission power of the SRS, Txpₛᵣₛ, based on the transmission power of the PUSCH transmission Txp_{PUSCH}. Afterwards, at 313, processor 123 can determine a difference between the transmission power of the SRS Txpₛᵣₛ and the receiving power of the SRS Rxpₛᵣₛ, by PLₛᵣₛ=Txpₛᵣₛ−Rxpₛᵣₛ. In some embodiments, the difference PLₛᵣₛ=Txpₛᵣₛ−Rxpₛᵣₛ can be determined based on feedback from base station 101 for some previously reported receiving power of a similar SRS. Based on the difference PLₛᵣₛ=Txpₛᵣₛ−Rxpₛᵣₛ and the measured transmission power of the SRS, Txpₛᵣₛ, the receiving power of the SRS, Rxpₛᵣₛ, can be calculated. Accordingly, at 315, processor 123 can determine the uplink pathloss based on the difference PLₛᵣₛ=Txpₛᵣₛ−Rxpₛᵣₛ.

In some embodiments, as an example, at 311, processor 123 can determine a transmission power 115 of the SRS Txpₛᵣₛ based on the transmission power 111 of the PUSCH transmission Txp_{PUSCH}. For example, some communication standards known to one having ordinary skills in the art may have known formulas for determining transmission power 115 of the SRS Txpₛᵣₛ based on the transmission power 111 of the PUSCH transmission Txp_{PUSCH}.

In some embodiments, when a sum of the transmission power 115 of the SRS Txpₛᵣₛ and the transmission power 111 of the PUSCH transmission Txp_{PUSCH} is not limited by a maximum transmit power level (MTPL), transmission power 115 of the SRS Txpₛᵣₛ can be determined based on transmission power 111 of the PUSCH transmission Txp_{PUSCH}. A power difference ΔM_{PRB} between a first transmission power used to transmit a first physical resource block (PRB) for SRS 133 and a second transmission power used to transmit a second PRB for PUSCH transmission 133 can be determined, and the transmission power 115 of the SRS Txpₛᵣₛ can be calculated by a formula Txpₛᵣₛ=Txp_{PUSCH}+ΔM_{PRB}. In some embodiments, ΔM_{PRB}=10 log₁₀(M_{SRS,b,f,C}/M_{RB,b,f,c}^{PUSCH}), where M_{SRS,b,f,c} can be the SRS bandwidth expressed in a number of resource blocks for the SRS transmission occasion on active uplink (UL) bandwidth part (BWP) b of carrier f of serving cell c, as defined in some communication standards, and M_{RB,b,f,c}^{PUSCH} can be the bandwidth of PUSCH resource assignment expressed in a number of resource blocks for PUSCH transmission on UL BWP b of carrier f of serving cell c, as defined in some communication standards.

In some embodiments, when a sum of transmission power 115 of the SRS Txpₛᵣₛ and transmission power 111 of the PUKE transmission Txp_{PUSCH} is limited by MTPL 114, transmission power 115 of the SRS Txpₛᵣₛ can be determined based on transmission power 111 of the PUSCH transmission Txp_{PUSCH} and a maximum power reduction (MPR) ΔMPR, based on a formula Txpₛᵣₛ=Txp_{PUSCH}−ΔMPR.

In some embodiments, transmission power 115 of the SRS Txpₛᵣₛ can be determined based on transmission power 111 of the PUSCH transmission Txp_{PUSCH} and a power difference ΔP_{MCS} determined based on one or more modulation and coding schemes (MCS), Txpₛᵣₛ=Txp_{PUSCH}+ΔP_{MCS}. The power difference ΔP_{MCS} can be determined based on a first MCS used when the receiving power of the SRS Rxpₛᵣₛ is being measured, and a second MCS that is adjusted based on an uplink Block Error Ratio (BLER) measurement. Base station 101 can evaluate UL MCS based codebook SRS, and further adjust MCS according to UL BLER. Base station 101 can derive MCS difference between initially scheduled MCS and the final used MCS.

In some embodiments, SRS 133 can be a narrowband SRS. The operations to calculate the pathloss can further include determining a difference value, ΔRxₛᵣₛ, between a narrowband SRS signal to noise ratio (SINR) calculated based on the receiving power of the SRS Rxpₛᵣₛ and an average SRS SINR; determining a narrowband PUSCH receiving power, NB Rxp_{PUSCH}, determining an average wideband receiving power for the PUSCH transmission, by a formula Avg Rxp_{PUSCH}=NB Rxp_{PUSCH}+ΔRxₛᵣₛ; and calculating the uplink pathloss based on the Txp_{PUSCH} and the average wideband receiving power for the PUSCH transmission Avg Rxp_{PUSCH}, by a formula PL_{PUSCH}=Txp_{PUSCH}−Avg Rxp_{PUSCH}.

Various aspects can be implemented, for example, using one or more computer systems, such as computer system 400 shown in FIG. 4. Computer system 400 can be any computer capable of performing the functions described herein such as UE 102 or base station 101 in FIG. 1, for operations described for processor 123 or process 300. Computer system 400 includes one or more processors (also called central processing units, or CPUs), such as a processor 404. Processor 404 is connected to a communication infrastructure 406 (e.g., a bus). Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to some aspects, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 408, the removable storage unit 418, the removable storage unit 422 can store instructions that, when executed by processor 404, cause processor 404 to perform operations for a UE, UE 102 or base station 101 in in FIG. 1, for operations described for processor 123 or process 300.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 400, main memory 408, secondary memory 410 and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 4. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a UE, base station, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of calculating an uplink pathloss by a user equipment (UE), comprising:
determining a transmission power of a physical uplink shared channel (PUSCH) transmission (Txp_{PUSCH}), wherein the PUSCH transmission is from the UE to a base station;
determining a receiving power of a sounding reference signal (SRS) at the base station (Rxpₛᵣₛ); and
calculating the uplink pathloss based on the Txp_{PUSCH} and the Rxpₛᵣₛ.

2. The method of claim 1, wherein the Txp_{PUSCH} is determined based on a power headroom report (PHR).

3. The method of claim 1, wherein the calculating the uplink pathloss comprises:
determining a transmission power of the SRS (Txpₛᵣₛ) based on the Txp_{PUSCH}; and
calculating the uplink pathloss based on a difference between the Txpₛᵣₛ and the Rxpₛᵣₛ by PLₛᵣₛ=Txpₛᵣₛ−Rxpₛᵣₛ.

4. The method of claim 3, wherein the Txpₛᵣₛ is determined based on the Txp_{PUSCH} and a power difference (ΔM_{PRB}) between a first transmission power used to transmit a first physical resource block (PRB) for the SRS and a second transmission power used to transmit a second PRB for the PUSCH transmission, wherein the Txpₛᵣₛ is calculated by Txpₛᵣₛ=Txp_{PUSCH}+ΔM_{PRB}, and wherein a sum of the Txpₛᵣₛ and the Txp_{PUSCH} is not limited by a maximum transmit power level (MTPL).

5. The method of claim 3, wherein the Txpₛᵣₛ is determined based on the Txp_{PUSCH} and a maximum power reduction (MPR) (ΔMPR), based on Txpₛᵣₛ=Txp_{PUSCH}−ΔMPR, and wherein a sum of the Txpₛᵣₛ and the Txp_{PUSCH} is limited by a maximum transmit power level (MTPL).

6. The method of claim 3, wherein the Txpₛᵣₛ is determined based on the Txp_{PUSCH} and a power difference ΔP_{MCS} determined based on one or more modulation and coding schemes (MCS), Txpₛᵣₛ=Txp_{PUSCH}+ΔP_{MCS}.

7. The method of claim 6, wherein the power difference ΔP_{MCS} is determined based on a first MCS used when the receiving power of the SRS Rxpₛᵣₛ is being measured and a second MCS that is adjusted based on an uplink Block Error Ratio (BLER) measurement.

8. The method of claim 1, wherein the SRS is a narrowband SRS, and the calculating the uplink pathloss comprises:
determining a difference value (ΔRxₛᵣₛ) between a narrowband SRS signal to noise ratio (SINR) calculated based on the Rxpₛᵣₛ and an average SRS SINR;
determining a narrowband PUSCH receiving power (NB Rxp_{PUSCH});
determining an average wideband receiving power for the PUSCH transmission (Avg Rxp_{PUSCH}), by Avg Rxp_{PUSCH}=NB Rxp_{PUSCH}+ΔRxₛᵣₛ; and
calculating the uplink pathloss based on the Txp_{PUSCH} and the Avg Rxp_{PUSCH}, by PL_{PUSCH}=Txp_{PUSCH}−Avg Rxp_{PUSCH}.

9. A user equipment (UE), comprising:
a transceiver configured to enable wireless communication over a wireless network with a base station; and
a processor communicatively coupled to the transceiver and configured to:
determine a transmission power of a physical uplink shared channel (PUSCH) transmission (Txp_{PUSCH}) from the UE to the base station;
determine a receiving power of a sounding reference signal (SRS) (Rxpₛᵣₛ); and
calculate an uplink pathloss based on the Txp_{PUSCH} and the Rxpₛᵣₛ.

10. The UE of claim 9, wherein Txp_{PUSCH} is determined based on a power headroom report (PHR).

11. The UE of claim 9, wherein to calculate the uplink pathloss, the processor is configured to:
determine a transmission power of the SRS (Txpₛᵣₛ), based on the Txp_{PUSCH}; and
calculate the uplink pathloss based on a difference between the Txpₛᵣₛ and the Rxpₛᵣₛ, by PLₛᵣₛ=Txpₛᵣₛ−Rxpₛᵣₛ.

12. The UE of claim 11, wherein the Txpₛᵣₛ is determined based on the Txp_{PUSCH}, and a power difference (ΔM_{PRB}) between a first transmission power used to transmit a first physical resource block (PRB) for the SRS and a second transmission power used to transmit a second PRB for the PUSCH transmission, wherein the Txpₛᵣₛ is calculated by Txpₛᵣₛ=Txp_{PUSCH}+ΔM_{PRB}, and wherein a sum of the Txpₛᵣₛ and the Txp_{PUSCH} is not limited by a maximum transmit power level (MTPL).

13. The UE of claim 11, wherein the Txpₛᵣₛ is determined based on the Txp_{PUSCH} and a maximum power reduction (MPR) (ΔMPR), based on Txpₛᵣₛ=Txp_{PUSCH}−ΔMPR, and wherein a sum of the Txpₛᵣₛ and the Txp_{PUSCH} is limited by a maximum transmit power level (MTPL).

14. The UE of claim 11, wherein the Txpₛᵣₛ is determined based on the Txp_{PUSCH} and a power difference (ΔP_{MCS}) determined based on one or more modulation and coding schemes (MCS), Txpₛᵣₛ=Txp_{PUSCH}+ΔP_{MCS}.

15. The UE of claim 14, wherein the ΔP_{MCS} is determined based on a first MCS used when the Rxpₛᵣₛ is being measured, and a second MCS that is adjusted based on an uplink Block Error Ratio (BLER) measurement.

16. The UE of claim 9, wherein the SRS is a narrowband SRS, and the processor is further configured to:
determine a difference value (ΔRxₛᵣₛ) between a narrowband SRS signal to noise ratio (SINR) calculated based on the Rxpₛᵣₛ and an average SRS SINR;
determine a narrowband PUSCH receiving power (NB Rxp_{PUSCH});
determine an average wideband receiving power for the PUSCH transmission (Avg Rxp_{PUSCH}), by Avg Rxp_{PUSCH}=NB Rxp_{PUSCH}+ΔRxₛᵣₛ; and
calculate the uplink pathloss based on the Txp_{PUSCH} and the Avg Rxp_{PUSCH}, by PL_{PUSCH}=Txp_{PUSCH}−Avg Rxp_{PUSCH}.

17. A non-transitory computer-readable medium storing instructions that, when executed by a processor of a user equipment (LTE), cause the UE to perform operations, the operations comprising:
determining a transmission power of a physical uplink shared channel (PUSCH) transmission (Txp_{PUSCH}), wherein the PUSCH transmission is from the UE to a base station;
determining a receiving power of a sounding reference signal (SRS) by the base station, Rxpₛᵣₛ; and
calculating an uplink pathloss based on the Txp_{PUSCH} and the (Rxpₛᵣₛ).

18. The non-transitory computer-readable medium of claim 17, wherein the Txp_{PUSCH} is determined based on a power headroom report (PHR).

19. The non-transitory computer-readable medium of claim 17, wherein the calculating the uplink pathloss comprises:
determining a transmission power of the SRS (Txpₛᵣₛ), based on the Txp_{PUSCH}; and
calculating the uplink pathloss based on a difference between the Txpₛᵣₛ and the Rxpₛᵣₛ, by PLₛᵣₛ=Txpₛᵣₛ−Rxpₛᵣₛ.

20. The non-transitory computer-readable medium of claim 19, Wherein the Txpₛᵣₛ is determined based on the Txp_{PUSCH}, and a power difference (ΔM_{PRB}) between a first transmission power used to transmit a first physical resource block (PRB) for the SRS and a second transmission power used to transmit a second PRB for the PUSCH transmission, wherein the Txpₛᵣₛ is calculated by Txpₛᵣₛ=Txp_{PUSCH}+ΔM_{PRB}, and wherein a sum of the Txpₛᵣₛ and the Txp_{PUSCH} is not limited by a maximum transmit power level (MTPL).
